(19) United States
(12) Patent Application Publication
(10) Pub. No.: US 2006/0044206 A1
(43) Pub. Date: Mar. 2, 2006

(54) Shielding wireless transponders

(76) Inventors: Paul A. Moskowitz, Yorktown Heights, NY (US); Robert J. von Gutfeld, New York, NY (US)

Correspondence Address: IBM CORPORATION, T.J. WATSON RESEARCH CENTER, P.O. BOX 218, YORKTOWN HEIGHTS, NY, 10598, US

(21) Appl. No.: 10/927,853

(22) Filed: Aug. 27, 2004

(51) Int. Cl. H01Q 1/52; G08B 13/14

(52) U.S. Cl. 343/841; 340/572.7; 340/572.8

(57) ABSTRACT

Provides protection to wireless portable transponders from an unauthorized interrogation by employing a mechanical member. Transponders include: cards, fobs and RFID tags that a persons may carry. Such transponders generally have means for receiving and storing electronic and other information, commonly in binary form using memories as in electronic circuits, etc. The invention is designed to provide privacy of electronic information and yet permit the information to be queried at the users discretion. The cards and tags can be protected from receiving or providing unauthorized or unwanted information. The invention provides a standard carrying case with radio wave shielding means that permit the owner to decide when reception/interrogation of personal or other information is desirable by placing the cards, fobs and RFID tags within the shielded region.

### FIELD OF THE INVENTION

The present invention is related to providing portable wireless transponders, such as cards and RFID tags, with user controlled mechanical protection from an unauthorized interrogation. More particularly, the invention provides mechanical means that permit a user to decide when transponder reception/interrogation of personal or other information is desirable.

### BACKGROUND OF THE INVENTION

Portable wireless transponders, employ RFID, Radio Frequency Identification, as the technology used to collect highway tolls, to serve as personal identification for access control, and to provide means for electronic information interchange, such as credit, etc. Passive RFID tags and wireless cards contain chips, (also known as computer chips, microchips, memory chips) which store identification and other information, such as credit card numbers, financial data, etc. Tags may be applied to items to identify the item in much the same way that bar codes are used. Information is retrieved from a tag as well as the wireless cards of the present invention by an RFID base station or reader when the tag or card is scanned with radio waves by the reader. The tags may draw their power to function from the interrogation field supplied by the base station which reads or writes information to the tag or card.

Such tags, passive tags, are described in U.S. Pat. No. 3,713,148, Card Apparatus and System, issued to Cardullo and Parks. In its simplest form the RFID tag or device includes a circuit typically a silicon chip, although more than one chip may be used in the construction of the RFID device. The circuit is generally connected to an antenna. The RFID device or card may take on a variety of forms including that of a tag, a key fob, or a card. A battery may also be employed to extend the range of the device. It is also possible in principle to build devices that function as tags or wireless cards using electrical circuits including only resistors, capacitors and inductors as is well known by those skilled in the art. In some cases the circuit acts as an antenna and thus a separate antenna is not used.

Other tags may contain a set of magnetic wires or a set of resonant devices, neither of which contain separate antennae to receive or send a signal upon interrogation but still have memory functions that may be interrogated in a manner similar to tags comprised of an antenna and chip. There are also non-electrical circuit memory devices, which are responsive to interrogation, that may be used to construct identification devices contained within cards and tags. Examples of such memory devices include magnetic devices, or wires such as those described in U.S. Pat. No. 5,538,803, “Multibit Tag Using Barkhausen Effect,” resonant structures such as are describe in U.S. Pat. No. 5,563,583, “Multibit Magnetic Radiofrequency Tag Using Micromechanics,” and U.S. Pat. No. 5,581,257, “Radio Frequency Automatic Identification System”.

Wireless RFID transponders may operate at a variety of frequencies including low frequency, LF, high frequency, HF, ultra-high frequency, UHF, and microwave frequencies. The LF and HF transponders generally communicate with an RFID reader by coupling to the magnetic component of an electromagnetic, EM, signal or wave, while UHF and microwave frequency transponders are coupled through the electric component of the EM wave.

Large scale retailers and their suppliers are pursuing Radio Frequency Identification, RFID, tagging for supply chain tracking of goods. Demonstrations of RFID for item tagging will lead to point of sale check out and data collection. At the same time merchants are also issuing credit/debit cards that allow a holder to be identified upon entering a place selling merchandise. The most common type of card for these applications is one that contains a silicon chip connected to an antenna though other types of memory devices, as already mentioned also exist. This most commonly used ‘wireless’ card may be in the form of a credit card that has in it an RFID chip positioned between laminates of the card as well as an antenna attached to the chip, also generally placed within the card laminates. Since the card communicates by a wireless means, it may take other physical forms. For example, Speedpass (www.speedpass.com) is a wireless RFID credit device that has the form of a small cylinder or key fob. It is carried on a key chain. Likewise, American Express has introduced an RFID credit card, ExpessPay (www.americanexpress.com/expresspay) which is in the form of a rectangular key fob.

The issue of privacy is of utmost concern. Users carrying RFID identification cards or consumers who purchase tagged items may be concerned with the possibility of unauthorized reading of cards or tags and the compromising of personal information contained within the memory of their cards or tags as well as having unauthorized information placed onto their cards while carrying these cards in their attache cases, briefcases, purses, handbags, shopping bags, back packs, book bags, or the like.

### SUMMARY OF THE INVENTION

It is the purpose of the present invention to provide electromagnetic shielding for carrying cases or case or enclosures to make it possible for the holder of one or more RFID or wireless identification cards (as well as items with RFID tags that are still enabled) to be placed into shielded case or enclosures to protect the privacy of the user or holder. The shielding of the case or enclosure effectively deactivates the RFID cards or RFID tags (that may be attached to items such as books, or items purchased in a retail store) and other electronic memory devices that may be interrogated by electromagnetic waves. The re-activation or unshielding of the card or tags carried by the owner or the user is accomplished by removal of the wireless card, tags or tagged items from the shielded case or enclosure. This may occur when the person carrying the RF card or RF tag desires to be identified by a particular merchant upon entering the merchant's enterprise. The shielded carrying case or enclosure is generally employed when the RFID card is not in use to prevent the unauthorized detection or reading of the RFID device, particularly when the wireless card or tag is carried in public places such as the street, stores, modes of transportation and the like.

An important feature of the present invention is that the shielding of the carrying case need not detract from the exterior design and advantageously also not the interior design and overall functionality of what could otherwise be a standard or nonstandard carrying case such as a wallet, purse, handbag, briefcase or the like, used for the carrying of common everyday items such as papers, keys, money, identification cards, cosmetics, books, food, purchased items, personal items, writing instruments, eyeglasses etc. Therefore, the shielding is advantageously laminated between the interior and exterior of the carrying case with the shielding generally consisting of a thin layer or layers of highly electrically conducting alloys or elements such as copper or aluminum or a layer or layers of highly permeable magnetic material or a combination of high conductivity and high permeability materials. These shielding materials, or combination of electrical and magnetic materials will cause the attenuation of any interrogation signal designed to read or to impart information on the RFID card or tag, or other memory devices that may be interrogated by electromagnetic waves.

It is further the purpose of this invention to provide shielding of such a nature to shield wireless transponder cards or tags from either the magnetic or electric or both components of electromagnetic (EM) signals that can communicate with the wireless cards or tags.

### BRIEF DESCRIPTION OF THE FIGURES

FIG. 1 shows the system for carrying a case or enclosure containing an RF wireless card that cannot be accessed by RF because of shielding built into the case or enclosure.

FIG. 2 shows a metallic lining of shielding material that is in the form of an insert for a typical handbag or purse.

FIG. 3 shows a shielded purse with the shielding laminated between the outer surface and the inner surface of the purse without detracting from the general design or appearance of the purse as it would exist without the shielding.

FIG. 4 shows a carrying case, here a handbag, that has only a portion shielded so that the holder can choose to have the device shielded or unshielded using the same carrying case.

FIG. 5 illustrates a briefcase containing the shielding laminated (top view) and inside view.

FIG. 6 is a flow chart illustrating the method of use of the invention.

### DETAILED DESCRIPTION OF THE INVENTION

The present invention provides methods, systems and apparatus to protect wireless transponders, such as cards, fobs or RFID tags that may be carried on a person within a carrying case or enclosure from an unauthorized interrogation. Such cards or tags have means for receiving and storing electronic information, commonly in binary form using memories and/or electronic circuits, typically, but not exclusively such as chips containing “bits” to store the information. The invention is designed to provide privacy for this type of electronic information and yet permit the information to be queried at the users discretion. At the same time, the cards and tags can be protected from receiving unauthorized or unwanted information. The invention provides means that permit a user, generally the owner or holder of a wireless transponder, to decide when reception or interrogation of this personal information is desirable by simple mechanical means.

Since the issue of privacy is of concern, it is most desirable under some circumstances to temporarily deactivate or disable at least the RFID portion of the card. It is the purpose of the present invention to make it possible for the holder of the card to protect his/her privacy by shielding, effectively deactivating, the RFID portion of the card at will, while also making it possible to reactivate the card or tag at the holder's discretion. The desire to activate or deactivate is likely to be a matter of choice decided by the holder of the card as to whether the holder wishes to be identified by a particular merchant upon entering a merchant's enterprise or environs. The deactivation also provides protection against undesired or unauthorized reading of cards and tags in public spaces. In addition, activation and deactivation of the RFID portion of the tag or card makes it possible for the holder of the tag or card to select whether or not additional information should be entered onto the card or tag from known or unknown RF sources.

In the present invention, we provide an advantageous means for activating or deactivating a tag that causes little or no disruption to the intrinsic card or tag operating system. Rather, means are provided to obtain the objective of enabling or disabling the card or tag at the card holder's choice. We create a carrying case or enclosure that is lined with material that will shield a major fraction of any RF radiation that can be directed at the case or enclosure and hence at the wireless card or tag. The RF shielding material, advantageously one or more thin sheets of metal electrically conducting and high magnetic permeability is built into the carrying case such as a wallet, handbag, briefcase, or shopping bag without disturbing the style or function of the carrying case that it has without the shielding material. The RF material thereby protects or shields the antenna on the card or any electrical memory circuit without an antenna from radiation that may be used to interrogate the card. This shielding material completely surrounds at least a portion of the carrying case where the items can be placed that are not to be reachable by RF so that radiation from any direction is prevented from reaching the RF sensitive device either for interrogation or from changing the information of the device's memory. The case or enclosure may also have a section that is unprotected or unshielded from RF radiation. If the owner wishes to be recognized via interrogation of the wireless card or tag, the owner removes the tag from the protective case or enclosure. If the carrying case or enclosure has a separate section that is not RF shielded, the holder of the wireless device transfers the device into the unprotected portion of the carrying case or enclosure or places it into a conventional pocket that is part of everyday clothing.

As used herein the term card includes any type of portable transponder. The wireless portable transponder, a card and/or tag, may have a dual purpose, that is it may act as a magnetic swipe card while also having the RFID identification.

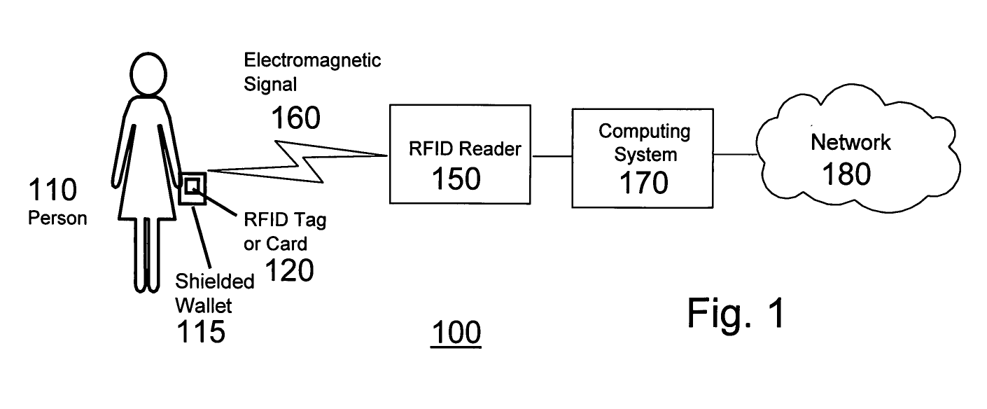

FIG. 1 illustrates a system of the invention 100. A person or card holder 110 carries at least one wireless card or identification card 120 with the card contained within an RF shielded case or enclosure 115, the card being interrogated by an RFID reader, the reading transmitted to a computing network when carried in a conventional carrying case, not protected by the shielding of this invention. The card when not contained within the shielding case or enclosure 115 may be read through the use of an electromagnetic, EM, signal 160 that provides means for communication between the card 120 and a reader 150. Information received by the reader 150 may be transferred to a computing system 170 where it is processed and stored in a database. The system 170 may in turn be connected to a network 180 which makes possible the exchange of information with other computing systems.

In order to protect the privacy of the person 110, the card is placed within the shielded carrying case or enclosure 115 where the shielded case or enclosure may be a wallet, pocketbook, handbag, briefcase and the like. The shielding of case or enclosure 115 may line the entire carrying case or enclosure or be only a part of the carrying case or enclosure in order to prevent RF radiation 160 from reaching card 120. The shielding material may be copper, aluminum, mu metal, Metglas® or a combination thereof to list the most common materials generally used for shielding.

It is well known by those skilled in the art that magnetic shielding can be accomplished through the use of mu metal, Metglas®, or any high permeable magnetic material that has a reasonable coercivity, that is greater than several Oersteds. Mu metal is the generic name for materials that have a very high magnetic permeability. Both mu metal and Metglas® are alloy compositions which are basically permalloy or nickel-iron with varying amounts of cobalt, boron and other trace materials. In addition, these materials are designed to have exceedingly high permeabilities, on the order of 10 thousand to 1 million. Therefore, a circuit surrounded by such material can readily be protected from magnetic radiation depending on the thickness of the alloy, the alloy's coercive force, i.e. magnetic field, required to bring the material to a value of zero magnetization in a hysteresis loop) and the strength of the incoming radiation. There now exist special Metglas® formulations that have a high coercive force so that both these materials as well as mu metal can be used in thicknesses of greater than 0.001 cm to shield magnetic fields, reducing the incident field by 1 to 5 orders of magnitude depending on the thickness of the material. Where thicker material is used, the lower is the frequency of the electromagnetic wave incident on the card that may be shielded.

In general, the attenuation of an electromagnetic wave incident on a metal is given in terms of the skin depth of the material, δ (cm)
δ=[2/(ωσμ)]^{0.5} (1)
where ω, σ, μ are respectively, the angular frequency of the incident wave, electrical conductivity, and permeability of the shielding material. δ represents the depth, skin depth, within the shield at which the incident field has fallen to 37 percent of its incident value. Thus, for a depth equal to three skin depths into a shielding material, the incident field is reduced by 95 percent leaving 5 percent of the original field.

Electric Field Shielding: To obtain an understanding of the thickness of shielding material required for the present invention one can scale skin depth values from copper as taken from J. A. Stratton, ‘Electromagnetic Theory’ McGraw Hill, pg 504 (1941). For an angular frequency of ˜6000 radians/s, about 1 kHz, δ=0.21 cm.

Although the invention is suitable for any frequency wherein transponders operate, our most particular interest ranges presently in frequencies from around 100 kHz to 5.8 GHz. Wireless cards that are coupled through the electric component of the EM field operate at frequencies above 100 MHz, typically at 434 MHz, 915 MHz (869 MHz in Europe), or at microwave frequencies of 2.45 GHz and above. However, as a worst case example, we can consider the case of a card coupling to the electric field at 100 kHz. The skin depth for copper at 100 kHz is 0.02 cm using equation (1) and the reference cited above. Thus, an easily realizable 0.06 cm thickness of copper will shield an electric field coupled card operating at 100 kHz. At 14.56 MHz, 0.006 cm of copper is all that is required. This thickness will also be effective at all of the higher frequencies, 434 MHz and above, where electric field coupling is generally used. Typically we would use a copper thickness of 0.02 to 0.05 cm, at least an order of magnitude more than is needed, to attenuate any interrogation signal at 14.56 MHz and above.

Electric and Magnetic Field Shielding: Generally RFID cards that use magnetic coupling operate at frequencies of about 100 kHz to 14.56 MHz. To provide shielding, we employ mu metal or a Metglas® with relatively high coercive force (greater than 10 Oersteds). Using a value for the permeability of 10⁵ and a conductivity that is 1/50 that of copper, we obtain a value for δ of no more than about 10⁻⁴ cm. Thus, a mu metal thickness of about 10⁻³ cm or greater would work as a shield for any frequency at or above 100 kHz.

In an alternate embodiment, non metallic materials may be used to shield a wireless card, tag, or transponder from being interrogated. These materials are absorbers of radio waves. Radio wave absorbing materials are manufactured by TDK RF Solutions Inc. (www.emc-automation.com).

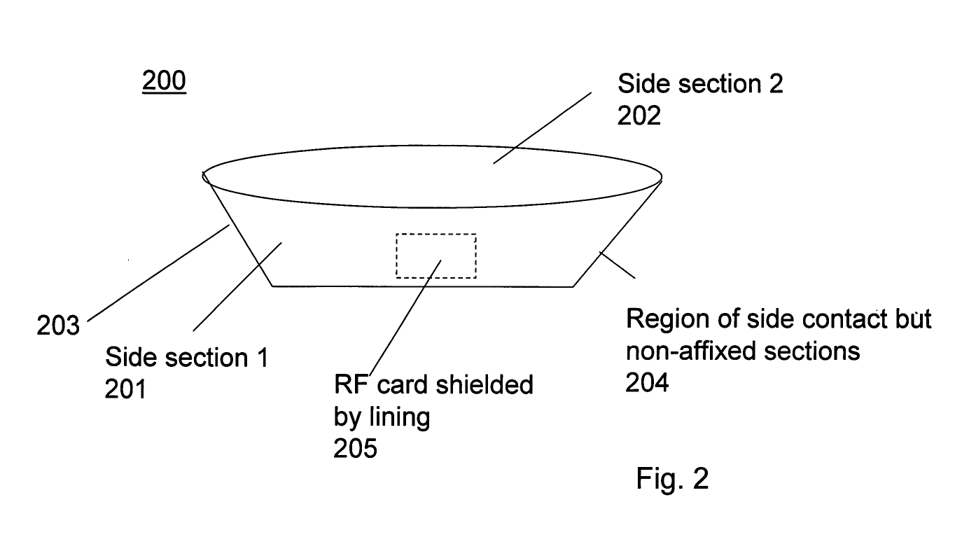

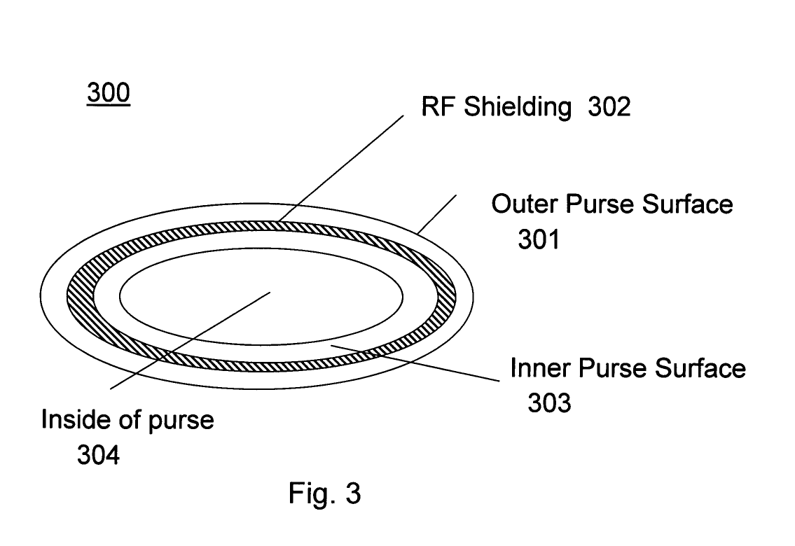

FIG. 2 illustrates the shielding in the form of a liner 200 that may be used as an insert in combination with a standard wallet, handbag, briefcase or the like. Here it is illustrated as a liner that might fit conformably into a standard handbag. The metal shielding consists of two thin metal sheets 201 and 202 that are advantageously in close contact with one another but are not rigidly affixed to one another at their respective ends 203 and 204. This close or loose contact provides the necessary shielding but also allows a standard carrying case such as a hand bag, purse, wallet, briefcase in the like to be opened and closed in the customary manner. Shown also in outline is an RF card 205 within the carrying case or enclosure 200 that is protected by the RF shielding material of 200. Alternatively, the two thin metal sheets 201 and 202 may be joined together at their ends 203 and 204 to form a single shielding envelope. FIG. 3 shows a top view 300 of a shield and the manner in which it can be laminated between different layers of a standard purse, wallet, handbag, or carrying case. Shown in FIG. 3 is the outer surface 301 consisting of the material ordinarily used for carrying cases, typically plastic, leather, cloth or the like. 302 is the RF shielding, 302 conforming to the outer or exterior surface 301 of the carrying case ins such a manner that the surface of the shielding lining is substantially equal to that of the outer surface. The inner layer 303 is again a layer of material that would typically be used for a carrying case, that is cloth, leather, plastic or a combination thereof. In the perspective shown 304 is the inside or interior of the carrying case in the perspective shown. The region 304 is shielded from EM waves.

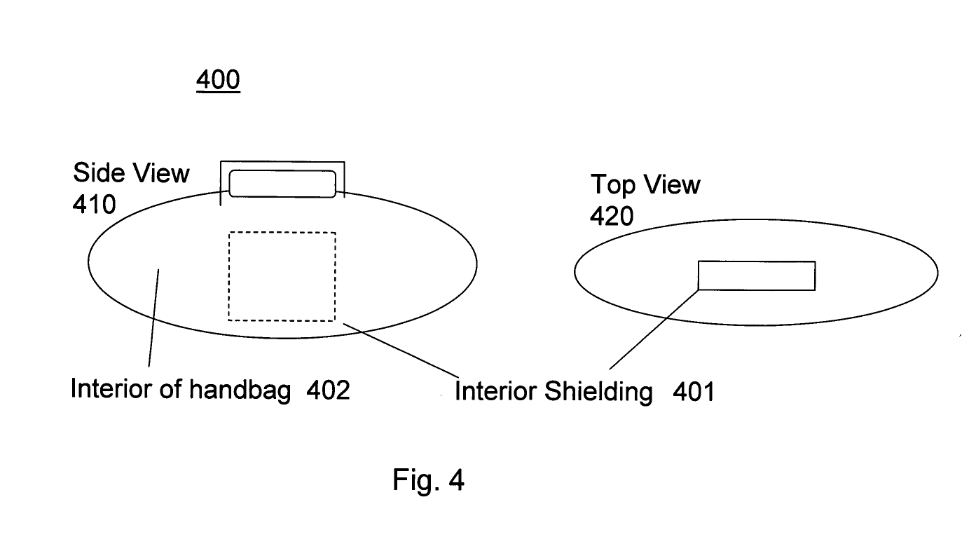

FIG. 4 shows a carrying case, here in the form of a handbag 400 where only a section of the carrying case consists of a shielded compartment 401. The handbag is shown in side view 410 and top view 420. This compartment 401 would have the basic form shown in FIGS. 2 and 3. A wireless card, wireless transponder, tag, or transponder may be placed either in the interior of the handbag within the shielded pouch or pocket 401 where it will be shielded from EM waves or within the interior of the bag 402, but exterior to the pocket 401, where it may be interrogated or read by EM waves. The pocket is smaller than the carrying case. It is sufficiently smaller that the remaining space in the interior of the carrying case may be used for common everyday objects. An additional pocket or pocket which are not shielded may be build into the carrying case in the interior portion of the carrying case that is not shielded.

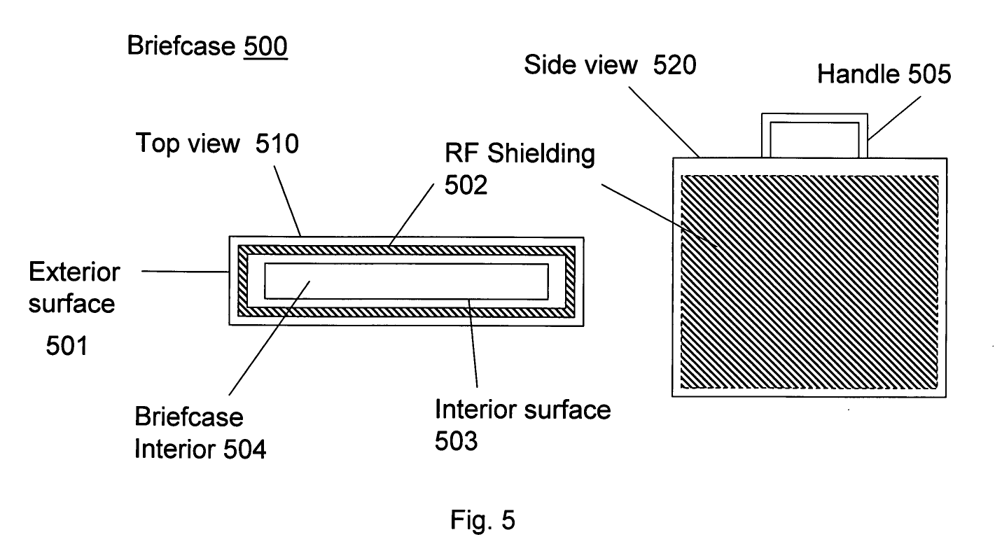

FIG. 5 shows the invention applied specifically to a briefcase 500. Both top view 510 and side view 520 are shown in this figure which is again very similar to that which is shown in FIGS. 2 through 4. Here, 501 is the outer or exterior surface of the briefcase made of material typically used for briefcases or attache cases such as leather, wood or possibly aluminum. In the case of aluminum, adequate shielding is not obtained for all RF frequencies that may be used to interrogate specific wireless cards or tags. 502 represents the RF shielding while 503 is the inner surface of the briefcase. The interior of the briefcase 504 is shown in the side view together with the handle 505. It should be stressed that for the range of frequencies requiring shielding, the shielding material may require the use of combination of both a highly permeable material and a material of high electrical conductivity such as copper. If only high frequencies (MHz range and above) are to be shielded than copper alone will be adequate as described above by equation (1) and the discussion that follows that equation. For a rectangular carrying case such as a briefcase, shielding may be placed on all six sides of the case.

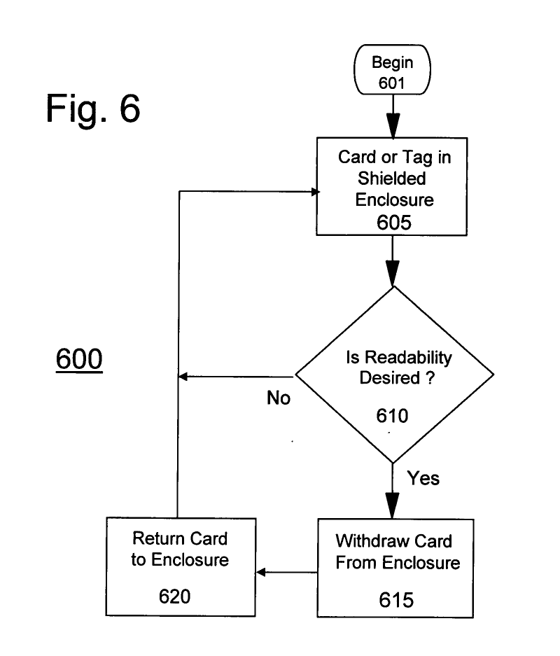

FIG. 6 summarizes the method of use of present invention in terms of a flow diagram 600. 601 is the starting point for the process while 605 indicates the wireless card or tag is in the shielded case or enclosure or carrying case. 610 gives the pathways that are used depending on whether it is desirable to have the tag interrogated or not. If the card is to be permitted to be interrogated, it is withdrawn from the shielded case or enclosure 615. Subsequently after allowing interrogation, the card is returned to the shielded case or enclosure (carrier) 620. If readability is not desired as in 610 the card is left in the shielded case or enclosure, 605.

The shielded carrying case invention can also be used to shield a portable transponder having a memory or circuit. Typically, the memory is a memory selected from a group of memories including: an electrical circuit and antenna, said antenna electrically coupled to said circuit; magnetic device; resonant structure; micromechanical device; non-electrical circuit memory device; and any combination of these circuits.

Typically, the transponder is one of the following: a credit card, a debit card, a fob, a transaction card, and a swipeable card. The transponder is typically carried by a person in order for a transaction to be performed. The transaction includes any giving and/or taking information to/from the card.

Thus, the invention includes a method for protecting one or more wireless transponders from an interrogation. An example of a method provides a shielded carrying case for carrying at least one transponder, using a carrying case to hold a plurality of items including at least one wireless transponder. The carrying cased is designed so that it enables the insertion of at least one transponder such that the shielded carrying case shields at least that one transponder from a radio frequency signal.

In some embodiments of the shielding method, the carrying case may be an enclosure, a purse, a wallet, a handbag, an attache case, a briefcase, a book bag, a back pack, or shopping bag. The shielded carrying case may include a shielded portion and a non-shielded portion. The carrying case may have shielding material laminated to at least a portion of a material forming the carrying capacity of the carrying case.

The carrying case may have the appearance of a standard carrying case wherein the carrying case has an exterior surface, and a lining interior to the exterior surface with the lining having radio wave shielding means.

The shielding property of the carrying case results from a shielding means taken from a group of shielding means consisting of materials having a high magnetic permeability such as mu metal and/or a material having a high electrical conductivity such as copper or aluminum, or a radio wave absorbing material. Any combination of these shielding materials may also be used. The shielding may have a thickness of at least 0.001 cm.

The carrying case may have a shielded portion which comprise a first pocket and a second pocket of sufficient size to hold at least one wireless transponder, that second pocket being shielded from RF radiation. The non-shielded pocket can be either the first or the second pocket of the carrying case.

The apparatus claimed is one of a carrying case for carrying a plurality of objects including at least one wireless transponder, the carrying case being at least partially lined by a shielding lining having a radio frequency shielding property with the shielding lining capable of shielding at least one transponder from a radio frequency interrogation signal when at least one transponder is inserted in said carrying case. The apparatus comprising the carrying case may have an exterior surface, and a radio frequency shielding lining positioned interior to said exterior surface or the lining may form an exterior surface of the carrying case.

The shielding lining may be laminated to the exterior surface of the carrying case. The RF shielding lining of the apparatus may be taken from a group of materials having a high magnetic permeability and/or electrical conductivity, and/or the shielding forming an exterior surface of the carrying case. The material with high electrical conductivity, may typically be copper, aluminum with a thickness of at least 0.001 cm in thickness. The material may also be one that has both a high magnetic permeability such as mu metal and a high electrical conductivity. Alternatively, the material may be one that has the property that absorbs radio waves.

The apparatus in the form of a carrying case is capable of carrying at least one wireless transponder and a plurality of common items with the carrying case having a radio frequency shielded interior portion or pocket of sufficient size to hold at least one wireless transponder. An additional portion of this carrying case may contain a second interior portion without the radio frequency property.

The apparatus in the form of a carrying case is one where the wireless card or fob, i.e. wireless transponder can be selectively enabled for receiving a radio frequency signal by removing the card or fob from the shielded portion of the carrying case completely or moving the wireless card or fob to a section of the partially shielded carrying case (shielded from radio frequency signals) thereby blocking the antenna of the wireless card or fob from receiving radio frequency signals. receiving an external radio frequency signal.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

We claim:

1. A method for protecting at least one wireless transponder from an interrogation, said method comprising:
providing a shielded carrying case for carrying said at least one transponder, said carrying case used for a plurality of items including said at least one wireless transponder; and
enabling insertion of said at least one transponder into said carrying case such that said shielded carrying case shields said. at least one transponder from a radio frequency signal.

2. A method as recited in claim 1, wherein said carrying case is one of: an enclosure, a purse, a wallet, a handbag, an attache case, a briefcase, a book bag, a back pack, and a shopping bag.

3. A method as recited in claim 1, wherein said shielded carrying case includes a shielded portion and a non-shielded portion.

4. A method as recited in claim 1, wherein said carrying case has shielding material laminated to at least a portion of a material forming a carrying capacity of said carrying case.

5. A method as recited in claim 1, wherein said carrying case has an appearance of a standard carrying case.

6. A method as recited in claim 1, wherein said carrying case has an exterior surface, and a lining interior to the exterior surface, said lining having radio wave shielding means.

7. A method as recited in claim 1, wherein a shielding property of said carrying case results from a shielding means taken from a group of shielding means consisting of: material having a high magnetic permeability; material having a high electrical conductivity; material being mu metal; material being copper; material being aluminum; a radio wave absorbing material; and any combination of these shielding means.

8. A method as recited in claim 1, wherein said shielding means has a thickness of at least 0.001 cm

9. A method as recited in claim 3, wherein said shielded portion comprises a first pocket of said carrying case of sufficient size to hold said at least one wireless transponder.

10. A method as recited in claim 9, wherein said non-shielded portion comprises a second pocket, said second pocket not having shielding means.

11. An apparatus comprising:
a carrying case for carrying a plurality of objects including at least one wireless transponder, said carrying case being at least partially lined by a shielding lining having a radio frequency shielding property, said shielding lining capable of shielding said at least one transponder from a radio frequency interrogation signal when said at least one transponder is inserted in said carrying case.

12. An apparatus as in claim 11, wherein said carrying case has an exterior surface, and said lining positioned interior to said exterior surface.

13. An apparatus as in claim 11, wherein said lining forms an exterior surface of said carrying case.

14. An apparatus as in claim 12, wherein said lining is laminated to said exterior surface.

15. An apparatus as in claim 11, where said lining has a limitation taken from a group of limitations consisting of: being a high magnetic permeability, being an exterior surface of said carrying case, having a high electrical conductivity; being made out of u metal; being made of copper, being made of aluminum, having a thickness of at least 0.001 cm in thickness, being of a material that has a high magnetic permeability and a material that has a high electrical conductivity; being of a material having properties of a radio wave absorbing material.

16. An apparatus comprising:
a carrying case for at least one wireless transponder and a plurality of common items, said carrying case having an interior portion of sufficient size to hold said at least one wireless transponder, said pocket having a radio frequency shielding property.

17. An apparatus as recited in claim 16, further comprising a second portion interior to said carrying case, said second portion not having a radio frequency shielding property.

18. A method as recited in claim 1, wherein the step of enabling comprises selectively moving said wireless transponder such as to block an antenna in said wireless transponder from receiving an external radio frequency signal.
